(19) United States
(12) Patent Application Publication
(10) Pub. No.: US 2022/0170480 A1
(43) Pub. Date: Jun. 2, 2022

(54) Micro Water Pump

(71) Applicant: AAC Microtech (Changzhou) Co., Ltd., Changzhou City (CN)

(72) Inventor: Detao Xu, Shenzhen (CN)

(21) Appl. No.: 17/534,391

(22) Filed: Nov. 23, 2021

(30) Foreign Application Priority Data
Nov. 27, 2020 (CN) 202022812157.8

(51) Int. Cl. F04D 29/42; H02K 5/10; H02K 11/33; F04D 17/10; F04D 29/22

(52) U.S. Cl. CPC F04D 29/426; H02K 5/10; H02K 2211/03; F04D 17/10; F04D 29/22; H02K 11/33

(57) ABSTRACT

The present disclosure provides a micro water pump, including: a housing having an accommodation part, an inlet and an outlet. A drive mechanism is installed in the housing for driving liquid. The drive mechanism includes a rotating shaft, an impeller, a rotor, and a stator. The impeller includes a support part, an installation part having a rotating shaft hole and extending from a middle of the support part, a fixed part extending from a periphery of the support part, multiple blades extending from the fixed part away from the installation part, and a glue storage groove formed by sinking from a junction of the support part and the fixed part. An extension direction of the installation part is same to an extension direction of the fixed part. Component interference caused by glue overflow during assembly is avoided.

### FIELD OF THE PRESENT DISCLOSURE

The present disclosure relates to fluid machinery, in particular to a micro water pump.

### DESCRIPTION OF RELATED ART

Micro water pump, usually used to lift liquids, transport liquids or increase pressure of liquids is called micro water pumps. It is currently widely used in new energy vehicles, computer water cooling systems, solar fountains, desktop fountains and other fields.

The micro water pump of related technologies includes a housing, a stator fixed in the housing, an impeller installed in the housing, a rotating shaft installed in the housing and supporting the rotation of the impeller, and a rotor fixed on the impeller and separated from the stator by a certain distance. The rotor of the related technology micro water pump is directly glued to the impeller. As a result, when the glue is not completely dry, the glue will easily overflow to the inner wall of the rotor through the gap between the rotor and the impeller, causing interference between the rotor and other devices.

Therefore, it is necessary to provide a more reliable micro water pump that can avoid component interference caused by glue overflow during the assembly process to solve the above problems.

### SUMMARY OF THE PRESENT INVENTION

One of the objects of the present invention is to provide a micro water pump with improved heat-dissipation performance.

To achieve the above-mentioned objects, the present invention provides a micro water pump, comprising: a housing having an accommodation part, an inlet communicated with the accommodation part, and an outlet communicated with the accommodation part; a drive mechanism installed in the housing for driving liquid from the inlet into the accommodation part and discharging from the outlet; the drive mechanism including a rotating shaft, an impeller in the accommodation part, a rotor engaging with the impeller, and a stator mounted with the base for driving the rotor to rotate.

The impeller comprises a support part, an installation part having a rotating shaft hole and extending from a middle of the support part, a fixed part extending from a periphery of the support part, multiple blades extending from the fixed part away from the installation part, and a glue storage groove formed by sinking from a junction of the support part and the fixed part. An extension direction of the installation part is same to an extension direction of the fixed part, and the rotor spaced from the support part is glued and fixed with an inner wall of the fixed part.

In addition, the rotor comprises a first surface close to the support part; the glue storage groove comprises a groove bottom surface; an orthographic projection of the groove bottom surface toward the first surface completely falls on the first surface.

In addition, the rotor further comprises a second surface arranged opposite to the first surface; the fixed part comprises a third surface away from the support part, and the second surface and the third surface are coplanar.

In addition, the rotor further comprises an inner wall surface and an outer wall surface connecting the first surface and the second surface; the outer wall surface is fixed to the inner wall of the fixed part by gluing.

In addition, the housing comprises a base and an upper cover assembled with the base; one of the base and the upper cover is provided with a sealed groove surrounding the accommodation part; the housing further comprises a sealing ring at least partially embedded in the sealed groove.

In addition, the base comprises a body part and a stator fixing slot formed by sinking from a surface of the body part away from the upper cover toward a direction close to the upper cover; the stator is embedded in the stator fixing slot.

In addition, the base further comprises an installation slot formed by sinking from the surface of the body part away from the upper cover toward the direction close to the upper cover; the micro water pump comprises a circuit board installed in the installation slot; for being electrically connected to the stator through a cable.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an isometric view of a micro water pump in accordance with an exemplary embodiment of the present disclosure.

FIG. 2 is an exploded view of the micro water pump in FIG. 1.

FIG. 3 is also an exploded view of the micro water pump, but from another aspect;

FIG. 4 is a cross-broken view of an impeller and a rotor of the micro water pump.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby is only to explain the disclosure, not intended to limit the disclosure.

It should be noted that all directional indicators (such as up, down, left, right, front, back, inside, outside, top, bottom . . . ) in the embodiments of the present invention are only used to explain that they are in a specific posture (As shown in the Fig. below), the relative positional relationship between the components, etc., if the specific posture changes, the directional indication will also change accordingly.

It should also be noted that when an element is referred to as being “fixed on” or “arranged on” another element, the element may be directly on the other element or there may be a centering element at the same time. When an element is referred to as being “connected” to another element, it can be directly connected to the other element or an intermediate element may be present at the same time.

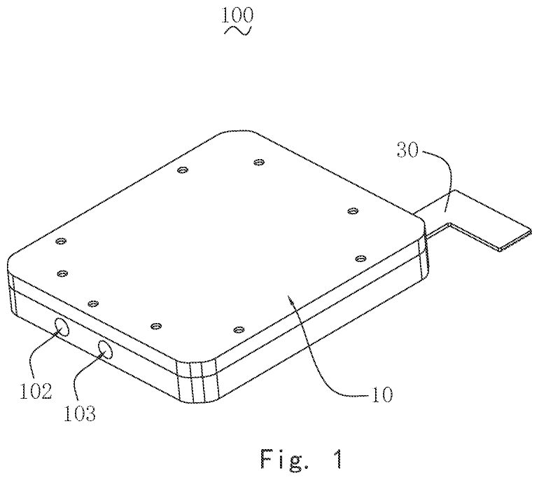

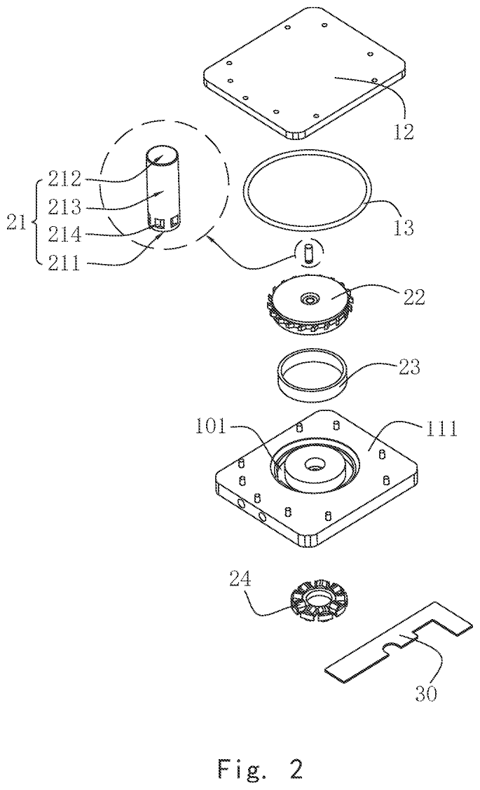

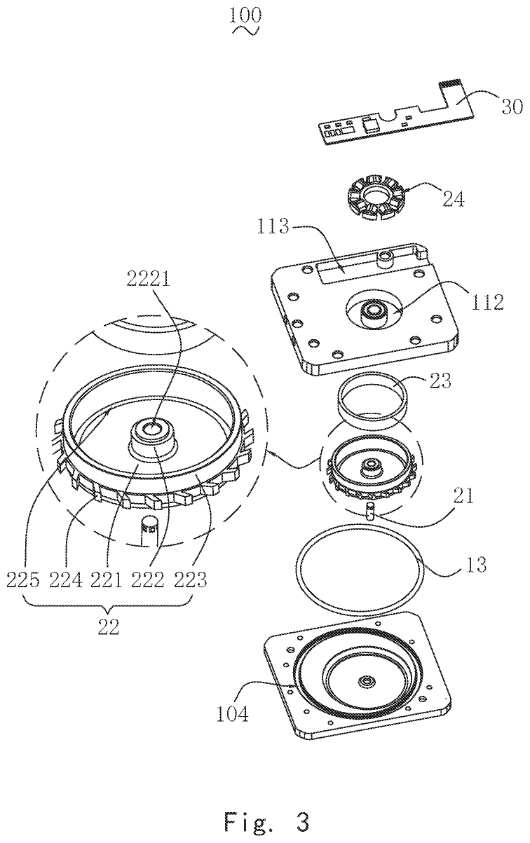

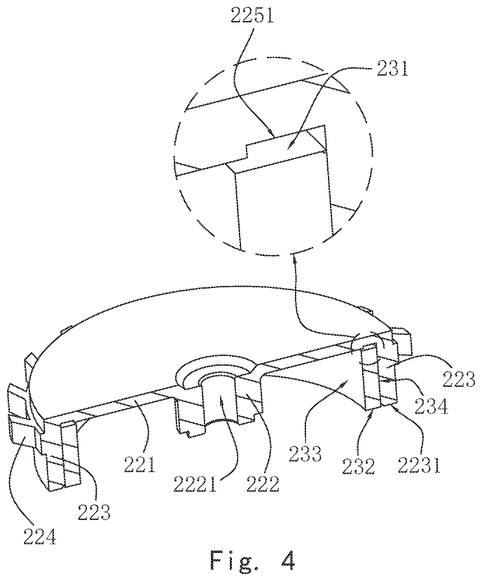

Please refer to FIGS. 1 to 4, the present invention provides a micro water pump 100 comprising a housing 10, a drive mechanism 20 accommodated in the housing 10, and a circuit board 30 set on the housing 10. Wherein, the housing 10 is provided with an accommodation part 101, an inlet 102 connected to the accommodation part 101, and an outlet 103 connected to the accommodation part 101. The drive mechanism 20 is installed in the housing 10 to drive liquid from the inlet 102 into the accommodation part 101 and discharge from the outlet 103.

The housing 10 comprises a base 11, an upper cover 12 combined with the base 11, and a sealing ring 13. The accommodation part 101 is enclosed by the base 11 and the upper cover 12. Wherein, one of the base 11 and the upper cover 12 is provided with a sealed groove 104 surrounding the accommodation part 101. The sealing ring 13 is at least partially embedded in the sealed groove 104 to prevent the liquid in the accommodation part 101 from leaking out of the gap between the upper cover 12 and the base 11.

The base 11 comprises a body part 111, a stator fixing slot 112 that is formed by sinking from the surface of the body part 111 away from the upper cover 12 toward the direction close to the upper cover 12, and an installation slot 113 close to the stator fixing slot and formed by sinking from the surface of the body part 111 away from the upper cover 12 toward the direction close to the upper cover 12. Wherein, the circuit board 30 is installed in the installation slot 113. The circuit board 30 and the drive mechanism 20 are electrically connected by a cable.

The drive mechanism 20 comprises a rotating shaft 21, an impeller 22 installed on the accommodation part 101, a rotor 23 installed on the impeller 22, and a stator 24 installed on the base 11 for driving the rotor 23 to rotate.

The rotating shaft 21 comprises a first end surface 211 and a second end surface 212 that are arranged relatively parallel, a sidewall surface 213 connecting the first end surface 211 and the second end surface 212, and a plurality of fixing slots 214 formed by sinking from an end of the sidewall surface 213 close to the first end surface 211 toward the axis. One end of the rotating shaft 21 close to the first end surface 211 is embedded in the base 11. A gap is arranged between the second end surface 212 and the upper cover 12. Of course, without limiting the present invention, the second end surface 212 may also abut against the upper cover 12.

When the fixing slot 214 is used for injection molding of the rotating shaft 21 and the base 11, the base 11 can be partially embedded in the fixing slot 214, making the connection between the rotating shaft 21 and the base 11 stronger.

Preferably, the plurality of fixing slots 214 have the same shape, and the plurality of fixing slots 214 are evenly distributed along the circumference of the rotating shaft 21.

The impeller 22 comprises a support part 221 with a circular cross section, an installation part 222 with a rotating shaft hole 2221 and extending from the middle of the support part 221, and a fixed part 223 extending from the periphery of the support part 221, a plurality of blades 224 extending from the fixed part 223 in a direction away from the installation part 222 and a glue storage groove 225 formed by sinking from the junction of the support part 221 and the fixed part 223.

The extension direction of the installation part 222 and the fixed part 223 are the same. The rotor 23 is glued and fixed to the inner wall of the fixed part 223 and is spaced apart from the support part 221. During the assembling process of the micro water pump 100, the rotating shaft 21 passes through the rotating shaft hole 2221, so that the impeller 22 can rotate around the rotating shaft 21. The fixed part 223 comprises a third surface 2231 away from the support part 221. The glue storage groove 225 comprises a groove bottom surface 2251. The rotor 23 comprises a first surface 231 close to the support part 221, a second surface 232 arranged opposite to the first surface 231, an inner wall surface 233 and an outer wall surface 234 connecting the first surface 231 and the second surface 232.

The orthographic projection of the groove bottom surface 2251 to the first surface 231 completely falls on the first surface 231. This configuration can ensure that the glue overflow between the rotor 23 and the impeller 22 is squeezed into the glue storage groove 225 during the assembly process, which improves the reliability of the micro water pump 100.

At the same time, in order to ensure the structural stability of the micro water pump 100 and save the internal space of the micro water pump 100, in this embodiment, the second surface 232 and the third surface 2231 are set to be on the same plane. The outer wall surface 234 is fixed to the inner wall of the fixed part 223 by gluing.

The stator 24 is embedded in the stator fixing slot 112. The circuit board 30 and the stator 24 are electrically connected by a cable.

During the working process of the micro water pump 100, the circuit board 30 energizes the stator 24 with alternating current. According to the principle of electromagnetic induction, the stator 24 generates a rotating magnetic field, the rotor 23 is rotated by the ampere force in the rotating magnetic field, and the rotating rotor 23 drives the impeller 22 to rotate. The liquid enters the accommodation part 101 from the inlet 102, and is driven by the impeller 22 to rotate at a high speed and perform centrifugal movement. When the liquid reaches the outlet 103, it is thrown out from the outlet 103. After the liquid is thrown out, the pressure in the accommodation part 101 decreases, much less than the atmospheric pressure. The external fluid is replenished from the inlet 102 into the accommodation part 101 under the action of atmospheric pressure, and the above-mentioned actions are repeatedly realized to realize the transportation of the liquid.

As for the micro water pump provided by the present invention, the glue storage groove is arranged at the junction of the support part and the fixed part, and the rotor is fixedly connected to the inner wall of the fixed part and is arranged at a distance from the support part. During the assembly process of the micro water pump, the glue overflowing between the rotor and the fixed part can be effectively prevented from being squeezed into the inner wall of the rotor, thereby avoiding interference between the rotor and other components.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A micro water pump, comprising:
a housing having an accommodation part, an inlet communicated with the accommodation part, and an outlet communicated with the accommodation part;
a drive mechanism installed in the housing for driving liquid from the inlet into the accommodation part and discharging from the outlet; the drive mechanism including a rotating shaft, an impeller in the accommodation part, a rotor engaging with the impeller, and a stator mounted with the base for driving the rotor to rotate; wherein
the impeller comprises a support part, an installation part having a rotating shaft hole and extending from a middle of the support part, a fixed part extending from a periphery of the support part, multiple blades extending from the fixed part away from the installation part, and a glue storage groove formed by sinking from a junction of the support part and the fixed part;
an extension direction of the installation part is same to an extension direction of the fixed part, and the rotor spaced from the support part is glued and fixed with an inner wall of the fixed part.

2. The micro water pump as described in claim 1, wherein the rotor comprises a first surface close to the support part; the glue storage groove comprises a groove bottom surface; an orthographic projection of the groove bottom surface toward the first surface completely falls on the first surface.

3. The micro water pump as described in claim 2, wherein the rotor further comprises a second surface arranged opposite to the first surface; the fixed part comprises a third surface away from the support part, and the second surface and the third surface are coplanar.

4. The micro water pump as described in claim 3, wherein the rotor further comprises an inner wall surface and an outer wall surface connecting the first surface and the second surface; the outer wall surface is fixed to the inner wall of the fixed part by gluing.

5. The micro water pump as described in claim 1, wherein the housing comprises a base and an upper cover assembled with the base; one of the base and the upper cover is provided with a sealed groove surrounding the accommodation part; the housing further comprises a sealing ring at least partially embedded in the sealed groove.

6. The micro water pump as described in claim 5, wherein the base comprises a body part and a stator fixing slot formed by sinking from a surface of the body part away from the upper cover toward a direction close to the upper cover; the stator is embedded in the stator fixing slot.

7. The micro water pump as described in claim 6, wherein the base further comprises an installation slot formed by sinking from the surface of the body part away from the upper cover toward the direction close to the upper cover; the micro water pump comprises a circuit board installed in the installation slot; for being electrically connected to the stator through a cable.
